(19) United States
(12) Patent Application Publication
(10) Pub. No.: US 2014/0099622 A1
(43) Pub. Date: Apr. 10, 2014

(54) HIERARCHICAL LEARNING ENVIRONMENT

(71) Applicant: AUTODESK, Inc., San Rafael, CA (US)

(72) Inventors: Adam ARNOLD, Orinda, CA (US); Martha ELLINGSON, Novato, CA (US); Jy-Huey LIN, Millbrae, CA (US); Thomas A. WILLIAMS, San Francisco, CA (US); Douglas LOOK, Ithaca, NY (US); John WALLACE, Ithaca, NY (US)

(73) Assignee: AUTODESK, Inc., San Rafael, CA (US)

(21) Appl. No.: 14/046,306

(22) Filed: Oct. 4, 2013

Related U.S. Application Data
(60) Provisional application No. 61/710,542, filed on Oct. 5, 2012.

(51) Int. Cl. G09B 5/00

(52) U.S. Cl. CPC G09B 5/00
USPC 434/308

(57) ABSTRACT

A design application allows one or more authors to create a learning path associated with a given topic. The learning path includes content curated from various online resources. The design application allows the authors to aggregate the content from the various online resources. The design application allows the author to curate content to include or associate with nodes. The design application also allows the authors to arrange the nodes in a hierarchy. When the learning path is complete, the design application presents the learning path to users. Users access the content within the learning path according to the hierarchy of the nodes. Advantageously, the author is able to present content, which may otherwise be distributed across the internet, within a cohesive learning path.

### CROSS-REFERENCE TO RELATED APPLICATIONS

This application claims benefit of U.S. Provisional Patent Application Ser. No. 61/710,542 filed Oct. 5, 2012, which is incorporated herein by reference in its entirety.

### BACKGROUND OF THE INVENTION

1. Field of the Invention

Embodiments of the present invention generally relates to techniques for online learning. More specifically, embodiments presented herein disclose techniques for curating and presenting digital content.

2. Description of the Related Art

Although the internet includes resources (e.g. videos, tutorials, documents, and websites) related to just about any topic, users regularly ignore these comparatively unstructured and dispersed resources when initially learning about an unfamiliar topic, e.g. when learning how to use a software tool. Instead, users commonly rely on more limited sources of online information (e.g., only documentation by the provider of a software tool), or on structured books and classes. When relying upon a narrow set of resources, users potentially ignore valuable online content from authors in a given topic. An author may provide valuable insight for both novice and experienced users. For instance, an author in a software tool could teach users about timesaving techniques or special features of the software tool.

Further, users who are initially learning an unfamiliar topic often find it difficult to find content—or to understand how the individual pieces of content that they do find relate to the overall topic area they are attempting to understand. The user may also have trouble developing an overall understanding of the topic from individual pieces of content. Frequently, users need to wade through a large amount of low-quality, tangential, or un-useful information to find information from good quality resources. In some cases, users may simply be unable to locate resources distributed throughout the internet. Again, even when the user locates some resource, the user may not know whether the resource includes valuable and accurate information. Furthermore, users already familiar with a topic can have difficulty locating novel content.

At the same time, valuable content may be available from a variety of online sources, not just a single publisher or web site; and that information changes rapidly. For example, experts or “fans” of a given software product may publish content that augments the documentation created by the provider of the software product. The provider of the software product may publish basic instructions and techniques for using the software product. However, experts among the extended user community often publish online content describing specific tips, tricks, or techniques for accomplishing detailed or complex operations. For instance, the documentation for a three dimensional (3D) modeling tool may teach users how to create basic 3D models, but an expert may publish a video tutorial teaching users how to add special textures to a 3D model.

### SUMMARY OF THE INVENTION

One embodiment of the invention includes a computer-implemented method for curating content within a learning path. This method may generally include receiving nodes associated with a topic, receiving an arrangement for the nodes defining the learning path, and, for each node, receiving curated content related to the topic to associate with the node. The method also includes storing each node and curated content in a repository and publishing the learning path.

One advantage of the disclosed technique is that an author may provide a learning experience by creating a cohesive presentation that facilitates an overall conceptual understanding of the subject, filled with curated content, which may otherwise be distributed across the internet and not available to the user in an organized fashion.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computing environment configured for curating and presenting content within a learning path, according to one embodiment.

FIG. 2 illustrates an interface for curating content in a learning path, according to one embodiment.

FIG. 3 illustrates an interface for presenting a learning path to a user, according to one embodiment.

FIG. 4 illustrates an interface for presenting a learning path, according to another embodiment.

FIG. 5 illustrates a method for authoring a learning path, according to one embodiment.

FIG. 6 illustrates a method for presenting content in a learning path, according to one embodiment.

FIG. 7 illustrates an example server computer configured with an authoring service and a presentation service, according to one embodiment.

FIG. 8 illustrates an example learning system, according to one embodiment.

### DETAILED DESCRIPTION

Embodiments presented herein provide techniques that allow users to curate and present content from virtually any online resource. In one embodiment, a learning environment allows experts on a given topic (e.g. a software tool) to curate content associated with that topic. Such users are generally referred to as authors. The learning environment also allows authors to organize and present the curated content within a learning path. The learning path organizes the content into a hierarchy of nodes, where a node may be a “child” of another node. Each node may include content associated with a sub-topic of the topic, e.g. a feature of a software tool. The learning environment includes an interface through which authors can acquire (or associate) content from online resources with the learning path, define the structure of the learning path (e.g., the hierarchy of nodes), and publish the learning path to users.

To acquire and organize content associated with a given topic, the learning environment may include an authoring service. The authoring service allows an author to aggregate content from virtually any online resource (or other source of information). The authoring service also allows the author to organize the aggregated content within nodes. The author may retrieve content by submitting the universal resource locator (URL) of an online resource to the authoring service. The online resource may include learning content associated with the topic, such as a video or tutorial document.

The authoring service also allows the author to provide a description or commentary about the online resource. In response to receiving the content from the author (e.g. a URL and description), the authoring service imports the content into the learning environment.

The author can also organize the content within multiple nodes of a learning path. That is, the authoring service allows the author to divide the topic into sub-topics by creating nodes for each sub-topic. The authoring service allows the author to arrange content within the nodes as well as arrange the nodes within the learning path

Thus, the learning environment allows the author to create a cohesive presentation (i.e. learning path) filled with content from many disparate sources. Furthermore, the learning path may include quality examples or demonstrations, regardless of whether the content originated from the author, a company affiliated with the author, or an unaffiliated resource. For instance, the learning environment would allow authors in a company selling a software tool to present a learning path that includes content from the company and content from unaffiliated resources, such as blogs, video sharing websites, or textbooks.

After the author creates the learning path, the environment can present the learning path to other users who want to learn about the topic. The environment may present the nodes of the learning path as a multi-level list or as a graph visually representing relationships between the nodes. When a user selects a node in either the multi-level list or graph, the environment presents the curated content associated with that node. Thus, the learning map guides the user through the curated content.

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

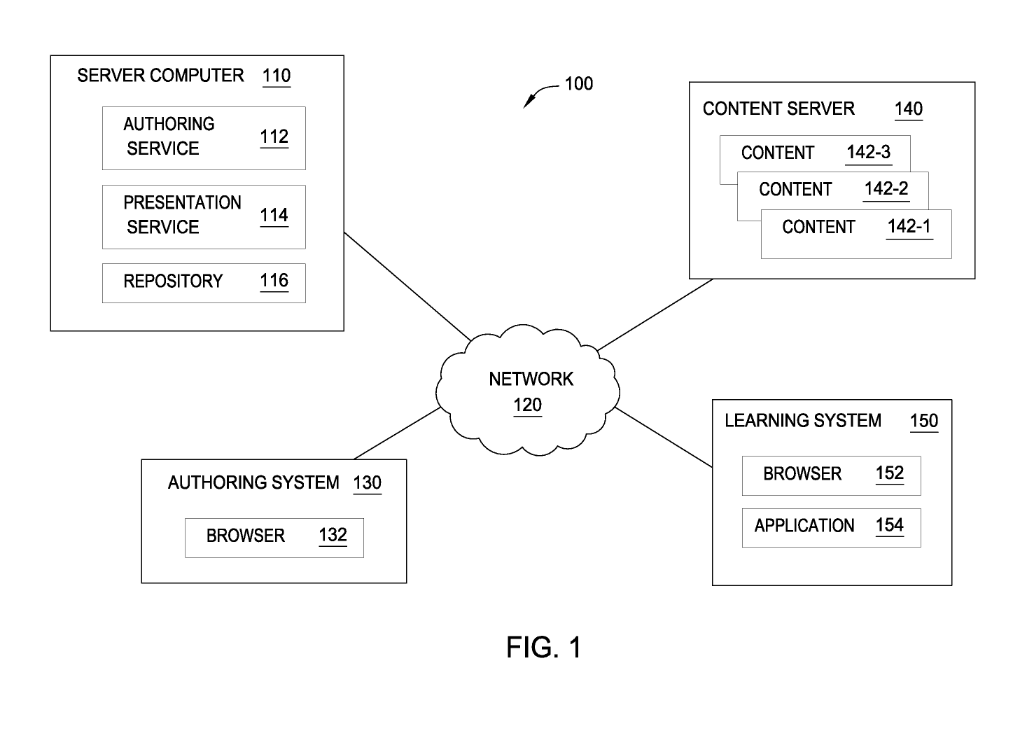

FIG. 1 illustrates a computing environment 100 configured for curating and presenting content in a learning path, according to one embodiment. The computing environment 100 allows an author interacting with authoring system 130 to create a learning path. The computing environment 100 allows a user at learning system 150 to learn about a given topic, e.g. a software tool. As shown, the system 100 includes a server computer 110 hosting an authoring service 112, a presentation service 114, and a repository 116. The server computer 110 may correspond to a physical computing system (e.g., a system in a data center) or may be a virtual computing instance executing within a computing cloud. In one embodiment, the author accesses the authoring service 112 using a browser 132 on authoring system 130. The authoring service 112 allows the author to create the learning path. The authoring service 112 stores the content and structure of a learning path composed by an author in the repository 116. The user accesses the presentation service 114 using a browser 152 on learning system 150. The presentation service 114 allows the user to view and interact with the learning path.

In one embodiment, the authoring service 112 allows the author to create the learning path as a hierarchy of nodes. For example, authoring service 112 may present an interface rendered in a browser 132, which allows the author to aggregate content for the nodes from various resources. The authoring service 112 also allows the author to create, edit, and arrange the nodes. As discussed, the authoring service 112 allows the author to divide a topic of the learning path into sub-topics by associating the content for a given sub-topic with a node. The hierarchy of the nodes in the learning path may indicate a sequence the author wants users to follow when learning about the topic. For instance, if the author is creating a learning path about a three-dimensional (3D) modeling tool, the author could place a node about designing 3D objects and a node about fabrication under a node with introductory content. Further, the author could place a node about 3D printing and a node about 3D machining under the node about fabrication.

The authoring service 112 stores the learning path within the repository 116. Relationships between nodes represent the hierarchy of the learning path. Accordingly, the repository 116 is configured to store the metadata associated with nodes (e.g. title, color, and position in a graph), the content of nodes, and the relationships between various nodes. The repository 116 may store multiple learning paths (each for a given topic). The repository 116 may store multiple versions of each of the learning paths. In one embodiment, the repository stores each learning path within an extensible markup language (XML) document.

The authoring service 112 allows the author to aggregate content from various resources with the nodes. As shown, a content server 140 includes content 142. The content server 140 may correspond to a physical computing system (e.g., a system in a data center) or may be a virtual computing instance executing within a computing cloud. The content 142 may include any form of digital information related to a topic including, e.g., videos, images, presentation slides, tutorials, textbook previews, downloadable files, referrals to electronic commerce partners, or reference documents associated with the topic. The content server 140 may present the content 142 within websites, such as blogs or video sharing sites. For instance, a wealth of content associated with the software tool may be available in blogs, social media websites, and video sharing websites. This content may be associated with the software tool, but not affiliated or sponsored by the company itself. In such a case, content server 140 could be a video sharing website and content 142-1, 142-2, and 142-3 could be video tutorials describing special features or techniques associated with the software tool. The authoring service 112 allows the author to curate content 142 for quality and then associate the curated content 142 with nodes of a learning path. That is, the author can present the unstructured wealth of information about a topic in an organized and cohesive manner.

The authoring service 112 associates the content 142 with one or more nodes, in response to the author submitting the URL of a content server 140, e.g. associating a node with a video from a video sharing website. The authoring service 112 may associated the content 142 to a given node, by adding a link to the content 142 to the node. The authoring service 112 may preserve the content 142 by importing the content 142 into the repository 116.

In addition, the authoring service 112 may suggest content 142 to associate with the node. For example, if the author selected an online resource (i.e. website) that includes a video, then the authoring service 112 may suggest associating the video, a title, a thumbnail image of the video, and a summary associated with the video. The author may then select what elements of the suggested content 142 to associate with the node. The authoring service 112 may also allow the author to modify the content 142, before the authoring service 112 imports the content 142. Extending the previous example, the author could edit the summary or crop the thumbnail image associated with the video.

The authoring service 112 may also derive additional content, based upon metadata that the authoring service 112 retrieves from the content server 140. For instance, the authoring service 112 may derive a set of keywords from the metadata. The authoring service 112 may suggest that the author include this additional content in the learning path.

After associating the content 142 with the node, the authoring service 112 may normalize the content 142 based on type of content or type of online resource. Doing so ay allow the authoring system to assist an author in organizing and managing content, as well as improve how content is pretend to a user. To do so, the authoring service may create configuration files to represent the content associated within node in a learning path. For example, assume an author links content from a video sharing website marked by that website as being “paid content.” In such a case, the authoring service could extract this information and store it in the content repository. Doing so may allow the authoring service 112 to enhance the presentation of that content to a user. For example, when published, the system may “turn off,” add, or remove information from content identifying it as “paid content” in the original source.

The authoring service 112 also allows the author to edit the node. The authoring service 112 allows the author to add additional content to the node, such as a description or summary. The authoring service 112 may also allow the author to create content previews that link to the content 142. A content preview may link to content 142 on the content server 140 or content 142 stored in the repository. For instance, instead of placing a video directly within a node, the author could place a link to the video within the node. When finished curating the content 142, the author can save the node in the repository 116. Thus, the authoring service 112 creates a node that includes the content 142 (or links to such content) in a learning path, and the resulting learning path is stored in a repository 116.

For instance, an author could create a learning path associated with a software tool. In such a case, content 142-1, 142-2, and 142-3 could include videos demonstrating different features of a software tool, thumbnail images of the video, and metadata describing the content. When the authoring service 112 receives a URL from the author, the authoring service 112 adds links to the content 142 to the node. The authoring service 112 could then suggest an arrangement for the thumbnail image, and a title derived from the metadata, within a node. The node itself is associated with the feature of the software tool. The author could provide a description, crop the thumbnail, and arrange the various pieces of contents 142 within the node. The authoring service 112 would then save the node, including the content 142, and the description, as part of the learning path.

A learning path may be designed for multiple types of users, e.g. professional and amateur users of a software tool. In one embodiment, the authoring service 112 may allow an author to save multiple versions of a learning path. The authoring service 112 may also allow the author to save multiple version of a node. Multiple authors may contribute to a learning path. Accordingly, in one embodiment, the authoring service 112 may allow an author to control contributions to the learning path. The authoring service 112 may allow an author to delegate tasks to other authors. For instance, an author could assign another author the task of building a particular node.

The authoring service 112 may allow an author to nest a learning path within another learning path. For example, a learning path associated with a software tool could include a node about a feature of that tool that itself was a distinct learning path For example if the node includes content pertinent to installing other software tools, then using the authoring service 112, an author could include the node in learning paths associated with the other software tools. When multiple learning paths include a node, the authoring service 112 may distribute changes made to the node across each learning path.

Once an author defines a learning path, and curates content for that learning path, the presentation service 114 makes the learning path available to users. A user may submit a request for the learning path through browser 152. In response to the request, the presentation service 114 retrieves the learning path from the repository 116. The presentation service 114 may initially retrieve metadata for the learning path, e.g. titles and arrangement of the nodes within the learning path. The presentation service 114 places the content 142 within a formatted document, such as a hypertext markup language (HTML) document. The presentation service 114 then transmits the document to the browser 152. The user may navigate the learning path by requesting to view the nodes within the learning path. The presentation service 114 responds by retrieving, formatting, and transferring the content 142 associated with the various nodes to the browser 152. By providing the content 142 within the nodes of the learning path, the presentation service 114 guides the user through the topic associated with the learning path.

For example, the user could be learning about an application 154 installed on the learning system 150, e.g. a software tool for building three-dimensional (3D) models. The developer of application 154 could have created a learning path associated with application 154. The user may access the learning path through the browser 152 on the learning system 150. The user could start with a node that includes content 142 introducing the application 154. While reviewing the first node, the user could watch a video tutorial on creating a simple 3D model with the application 154. The video tutorial could have originally been stored in a website that is not affiliated with the developer. The user would advance through the nodes of the learning path to learn additional information about the application 154. Thus, the learning path guides the user through learning about the application 154.

Of course, one skilled in the art will realize that the user may access the learning path from virtually any computing system that includes a browser, e.g. a personal computer, a tablet, or a mobile device. Further, the user may access a learning path associated with virtually any topic or application.

While learning about a topic, the user may access the learning path multiple times. To help the user remember which content 142 has been viewed, in one embodiment, the presentation service 114 tracks the progress of the user navigating the leaning path. The presentation service 114 may allow the user to mark a content 142 as already viewed. The presentation service 114 may also allow a user to mark a node as already viewed. In one embodiment, the presentation service 114 may include track the progress of the user. The presentation service 114 may record the progress within an account. That is, the presentation service 114 may associate each user that is using the learning environment with an account and record the progress of the user within the associated account. The presentation service 114 may then make this progress information available to the user. The presentation service 114 may also make this progress information available to various other users, e.g. the author that created a given learning path.

Additionally, in one embodiment, the presentation service 114 may retrieve different nodes or content 142 for different users. The presentation service 114 may also format the content 142 differently for different users. For instance, the presentation service 114 may highlight various nodes based upon the progress of a user. Likewise, the presentation service 114 may highlight various nodes based upon information within the account of the user, such as the interests or profession of the user.

The presentation service 114 may also record the usage of various learning paths. This usage information may include the number, the progress, or the geographic location of users that have used each learning path. The authoring service 112 may make this usage information available to the author or other users.

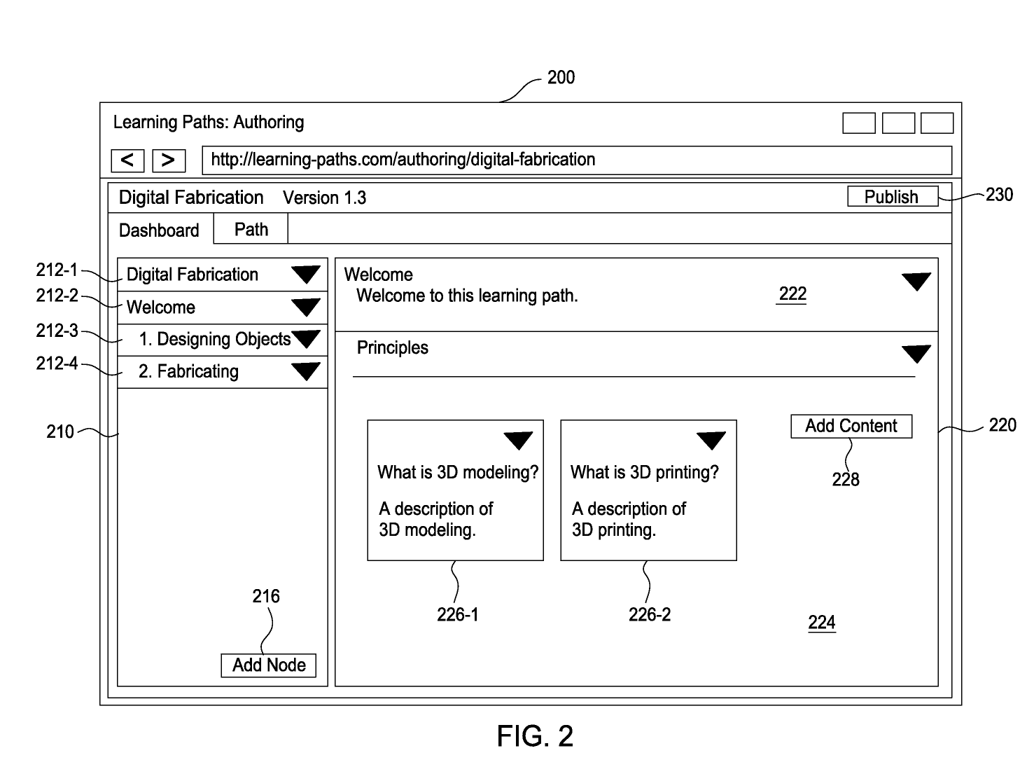

FIG. 2 illustrates an interface 200 for curating content 142 in a learning path, according to one embodiment. In this example, an author is presumed to have requested access to a learning path on the server computer 110 from a browser 132 on a client machine 130. In response, the authoring service 112 transmitted the interface 200 rendered by the browser 132. The author interacts with the interface 200 through the browser 132. As discussed, interface 200 allows the author to select, edit, and arrange content 142 within various nodes of a learning path. The interface 200 also allows the author to create, edit, and arrange the nodes within the learning path. As shown, the interface 200 includes region 210 and region 220. The region 210 displays a high-level view of the title and nodes within the learning path. The region 220 displays content 142 within a given node.

The region 210 includes interactive rows 212 associated with the learning path and various nodes of the learning path. The rows 212 each include a title and an arrow button. The title at row 212-1 is the title of the learning path, and the titles at rows 212-2, 212-3, and 212-4 are titles of nodes. As discussed, the author arranges the nodes in a hierarchy, where each node may be associated with a sub-topic of another node. In this example, the nodes labeled “1. Designing Objects” and “2. Fabricating” are sub-topics of the node labeled “Welcome.” As such, the rows 214-3 and 214-4 are located under and indented relative to row 214-2. The nodes associated with rows 214-3 and 214-4 are at the same level in the hierarchy of the learning path, so the rows 214-3 and 214-4 are displayed with the same indentation.

The authoring service 112 updates the learning path in response to the author interacting with the rows 212. In response to the author selecting the arrow button in row 212-1 (e.g. clicking a mouse pointer on the arrow), the interface 200 displays a list of possible actions for manipulating the learning path. The possible actions may include editing the title of the learning path, adding a node to the learning path, nesting a portion of another learning path within the learning path, or saving the learning path. The author may also add a new node by selecting the button 216 in region 210.

In response to the author selecting an arrow button of one of the rows 212-2, 212-3, or 212-4, the interface 200 displays a list of actions for manipulating the node. The actions may include editing the title of the node, changing the position of the node within the learning path, editing the content 142 within the node, or deleting the node. If the author selects to change the position of a node, then the interface 200 may allow the author to drag (e.g. with a mouse pointer) the title of the node to another row 212 or to indent the title of the node. In response to the author moving the title of a node, the authoring service 112 updates the arrangement of the node in the learning path. For instance, the author could further indent the title at row 212-4 to make the node “2. Fabricating” a sub-topic of “1. Designing Objects.”

If the author selects to edit the content 142 within a node, then authoring service 112 updates the interface 200 to display the content 142 of the node in region 220. In this example, the author is presumed to have requested to edit the “Welcome” node listed at row 212-2. As shown, region 220 includes a heading 222 and a chapter 224 for the selected node. The heading 222 includes the title of the node and an introduction. The chapter 224 includes a title, content preview 226-1 and 226-2, and a button 228. The various content previews 226 link to the content 142 associated with the node. As discussed, the author builds the learning path by adding content 142 to nodes. The interface 200 allows the user to add new content by selecting the button 228. In response to the user selecting button 228, the authoring service 112 may display a series of forms that guide the author through the process of importing new content.

The heading 222, chapter 224, and content previews 226 may include arrow buttons. In response to the author selecting the arrow button of the heading 222, the authoring service 112 may allow the author to update the text or formatting of the heading 222. In response to the author selecting the arrow button of the chapter 224, the authoring service 112 may allow the author to update the text of the chapter 224, arrange the content previews 226, or delete the chapter 224. In response to the author selecting the arrow button of a content preview 226-1, the authoring service 112 may allow the author to update the text of the content preview 226-1, update the content 142 that the content preview 226-1 links to, or delete the content preview 226-1 and associated content 142.

Although only one chapter 224 is shown, a node may include multiple chapters. The interface 200 allows the author to arrange content previews 226 within the various chapters 224 of a node. The interface 200 may also allow the author to place content 142 within a chapter 224, instead of content previews 226.

When the author finishes creating the learning path, the author may want to make the learning path available to users. Accordingly, the interface 200 includes a button 230 used to publish the learning path online. Before publishing the learning path, the authoring service 112 may request that the author provide information, such as a URL for the learning path or permissions for which users may access the learning path.

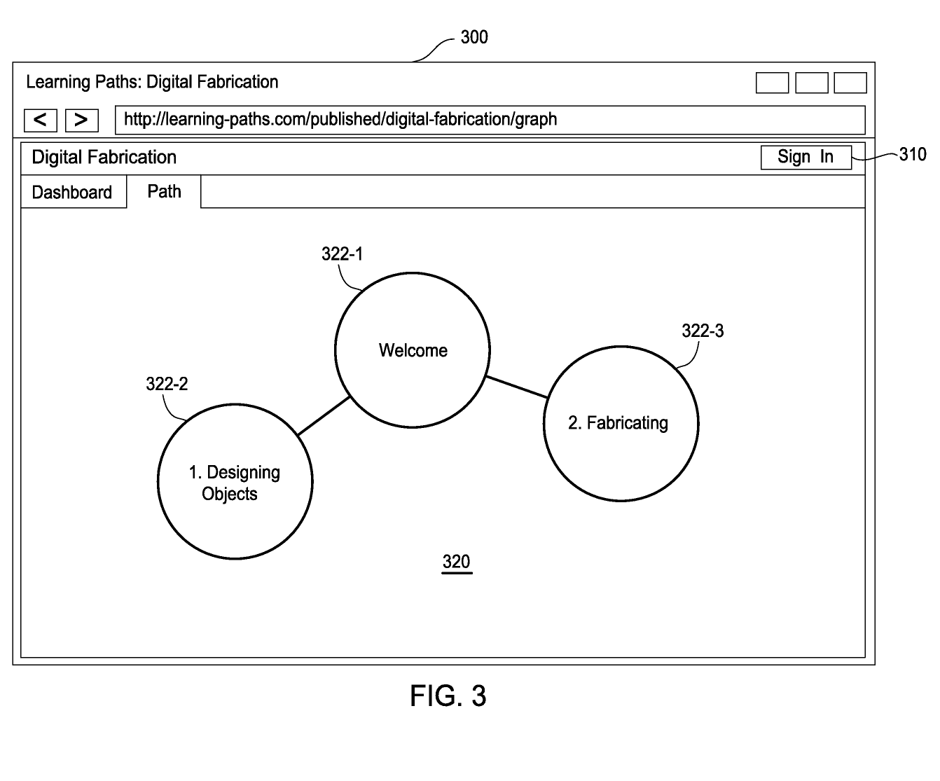

FIG. 3 illustrates an interface 300 for presenting a learning path to a user, according to one embodiment. In this example, a user is presumed to have requested access to a learning path on the server computer 110 from a browser 152 on a client machine 150. In response, the presentation service 114 transmitted the interface 300 rendered by the browser 152. The user interacts with the interface 300 through the browser 152. Interface 300 allows the user to interact with the learning path.

As shown, the interface 300 includes button 310 and region 320. In response to the user selecting button 320, the presentation service 114 allows the user to sign into a user account. As discussed, the presentation service 114 may target learning paths or content 142 to a given user, based upon the associated user account. The presentation service 114 may also record the progress of a user within a user account.

The region 320 displays a graph representation of a learning path. The graph visually represents the relationship between the nodes of the learning path. The graph includes icons 322-1, 322-2, and 322-3 that each represents a node. The lines from 322-1 to 322-2 and 322-3 indicate the relationship between the nodes. As shown, the nodes represented by icons 322-2 and 322-2 are sub-topics of the node represented by icon 322-1. The presentation service 114 may color the icons to differentiate the relationships. The user may view the content 142 of a given node, by selecting the node (e.g. tapping an icon 322 on touchscreen of the learning system 150). In response to the user selecting a node, the presentation service 114 transmits an interface that displays the content 142 of the selected node.

While shown as a two dimensional (2D) graph, in other embodiments, the presentation service 114 may display a learning path in a variety of formats. In one embodiment, the presentation service 114 may display a 3D representation of the learning path, e.g. nodes may be displayed with various heights. In other embodiments, the presentation service 114 may arrange the nodes to represent a fourth dimension, e.g. highlighting content 142 as the user progresses through the learning path. In still other embodiments, the presentation service 114 may target the arrangement of a learning path to different users. For example, the presentation service 114 may display a learning path about a 3D modeling tool with nodes associated with complex features of the 3D modeling tool for professional users. Whereas, the presentation service 114 may display the learning path with nodes describing simple projects for amateur users.

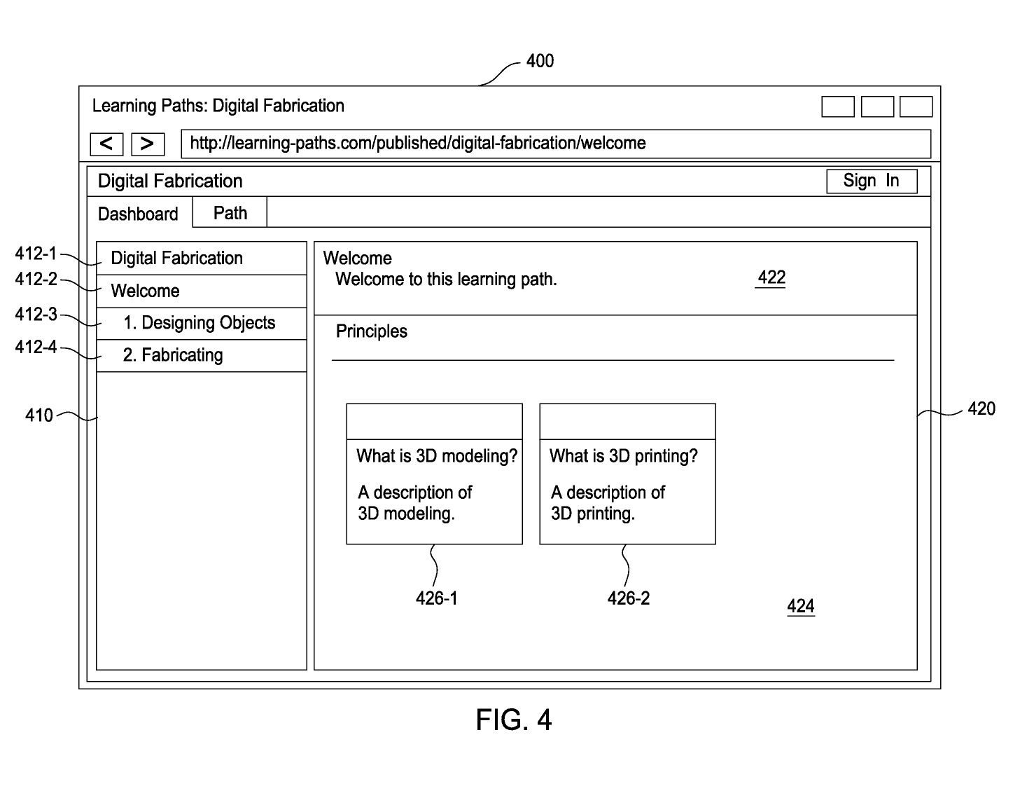

FIG. 4 illustrates an interface 400 for presenting a learning path, according to another embodiment. In this example, a user is presumed to have requested access to a node within a learning path on the server computer 110 from a browser 152 on a client machine 150. In response, the presentation service 114 transmitted the interface 400 rendered by the browser 152. The user interacts with the interface 400 through the browser 152. As discussed, interface 400 allows the user to review content 142 included within a node. As shown, the interface 400 includes region 410 and region 420.

The region 410 includes interactive rows 412 associated with the learning path and various nodes of the learning path. The rows 412 each include a title. Row 412-1 includes the title of the learning path. Rows 412-2, 412-2, and 412-3 include the titles of nodes within the learning path. The user may view the content 142 of a given node, by selecting the row 412 associated with the node.

If the user selects to view the content 142 within a node, then presentation service 114 updates the interface 400 to display the content 142 of the node in region 420. In this example, the user is presumed to have requested to view the “Welcome” node listed at row 412-2. In one embodiment, the user may have requested to view the “Welcome” node by selecting an icon within a graph representing the learning path. As shown, region 420 includes a heading 422 and a chapter 424 for the selected node. The heading 422 includes the title of the node and an introduction. The chapter 424 includes a title and content preview 426-1 and 426-2. The various content previews 426 are links to the content 142 associated with the node. That is, if the user selects a content preview 426 linked to a content 142, the presentation engine 114 transmits the content 142 to the browser 152. In other embodiments, the interface 400 may include the content 142 instead of the content previews 426.

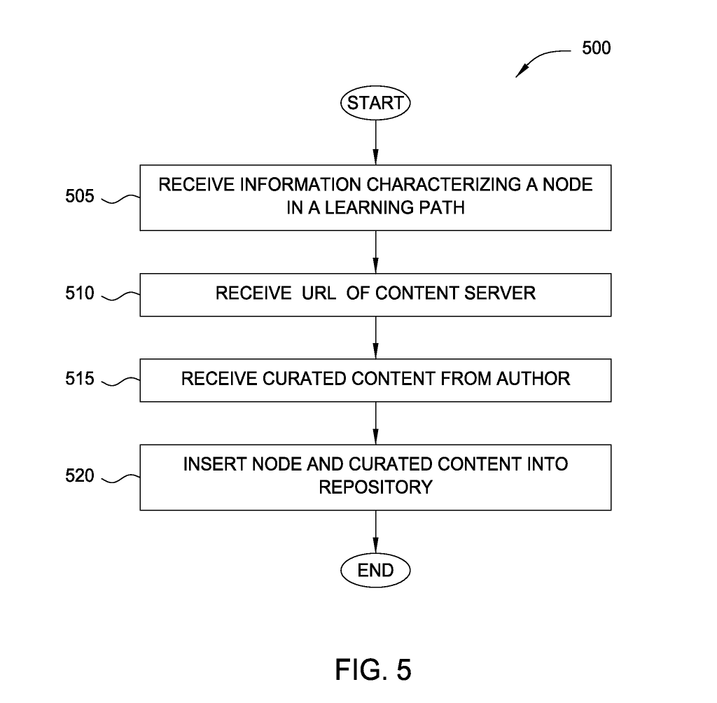

FIG. 5 illustrates a method for authoring a learning path, according to one embodiment. Although the method steps are described in conjunction with the computing environment of FIG. 1, persons skilled in the art will understand that any system configured to perform the method steps, in any order, is within the scope of the present invention.

As shown, method 500 begins at step 505, where the authoring service 112 receives information characterizing a node in a learning path. For example, the information may be for adding a new node in a new learning path or for adding a node to an existing learning path. The information may include a title and position of the node within the hierarchy of the learning path. For instance, if the author adds a node about 3D printing to a learning path about digital fabrication, then the authoring service 112 could receive the title “3D printing” and a position of the node. The position of the node could be as a sub-topic of a node on fabricating 3D objects.

At step 510, the authoring service 112 receives a URL of a content server 140. As discussed, the content server 140 may be a video sharing website or a blog. The authoring service 112 presents the content from the specified resource that may be included in the learning path. The authoring service 112 may present the content within an interface that allows the author to curate the content 142. For example, if the content server 140 is a video sharing website, then the authoring service 112 could retrieve a video, a thumbnail image, and various metadata. The authoring service 112 could derive a title and description from the metadata. The authoring service 112 could also normalize the content, e.g., the authoring service could strip overlays or graphics marking a video as being “paid content” or as being hosted by the video sharing website. More generally, the authoring service could remove (or add) other descriptive information to a video (or to other content). Further, the tool to present such content to users without the “paid content” marker added by the video sharing website. The authoring service 112 would then present the video, thumbnail image, title, and description to the author.

At step 515, the authoring service 112 receives curated content from the author. The author curates the content from the content server 140. For instance, if the author is creating a node about 3D printing and content server includes a video showing a 3D printer printing an object, then the author could select the video and provide a description of how a 3D printer functions.

At step 520, the authoring service 112 inserts the node and curated content 142 into the repository 116. That is, the authoring service 112 inserts the title, position, and curated content 142 associated with the node. The authoring service 112 adds the new node to the learning path by inserting the node and curated content 142 into the repository 116. Alternatively, the authoring service 112 could insert links to the content. For instance, after inserting the node, a learning path on digital fabrication could include a node about 3D printing as a sub-topic of fabrication. The method 500 then ends.

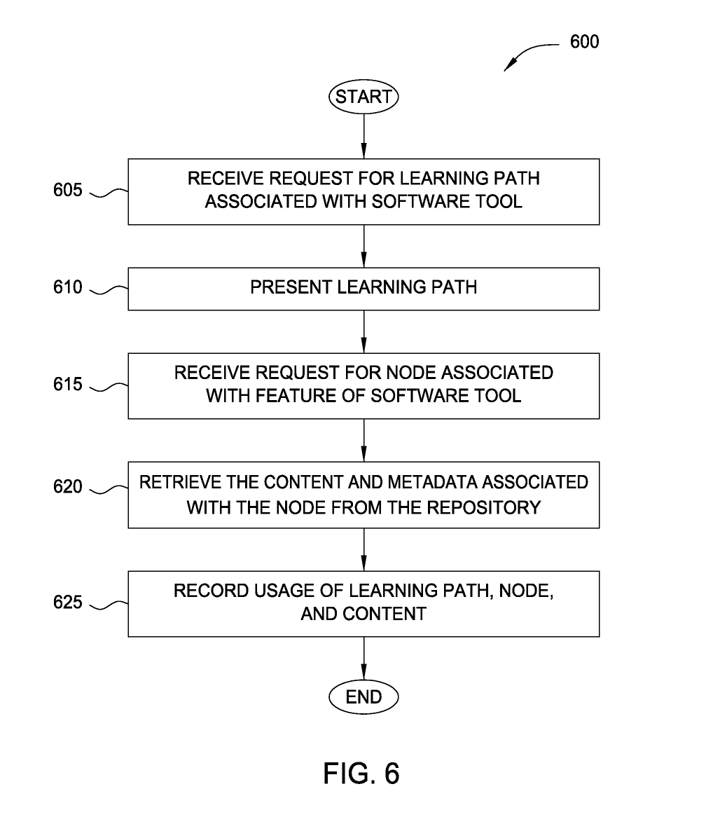

FIG. 6 illustrates a method for presenting content in a learning path, according to one embodiment. Although the method steps are described in conjunction with the computing environment of FIG. 1, persons skilled in the art will understand that any system configured to perform the method steps, in any order, is within the scope of the present invention.

As shown, method 600 begins at step 605, where the presentation service 114 receives a request for a learning path, e.g., a learning path associated with a 3D modeling tool. The request may include a URL associated with the learning path. The presentation service 114 may receive the request from a browser 152 running on a learning system 150. In response to receiving the request, the presentation service 114 presents the learning path, at step 610. To present the learning path, the presentation service 114 retrieves the metadata of the learning path from the repository 116. The metadata may include the relationships between the various nodes of the learning path. The presentation service 114 then creates a graph representing the learning path transmitted to the browser 152 for display to the user. As discussed, a learning path includes a hierarchy of nodes, where each node includes content associated with a sub-topic of the overall learning path. Thus, a graph for a 3D modeling tool may visually represent the various features of the software tool. The arrangement of the nodes (e.g. in a hierarchy) provide a sequence for learning about the software tool.

At step 615, the presentation service 114 receives a request for a node associated with a feature of the software tool. At step 620, the presentation engine 114 retrieves the content 142 and metadata associated with the node from the repository 116. The presentation engine 114 may then combine the content 142 into a document about the feature, e.g. a HTML document. The presentation engine 114 may format the document according to the metadata. After creating the HTML document, the presentation engine 114 transmits the document to the browser 152.

At step 625, the presentation service 114 records the usage of the learning path, node, and content 142. The presentation service 114 may record that the user has accessed the learning path and the node. The presentation service 114 may also monitor which content 142 within the node that the user reviews. The presentation service 114 may record this usage information within a user account associated with the user. The method 600 then ends.

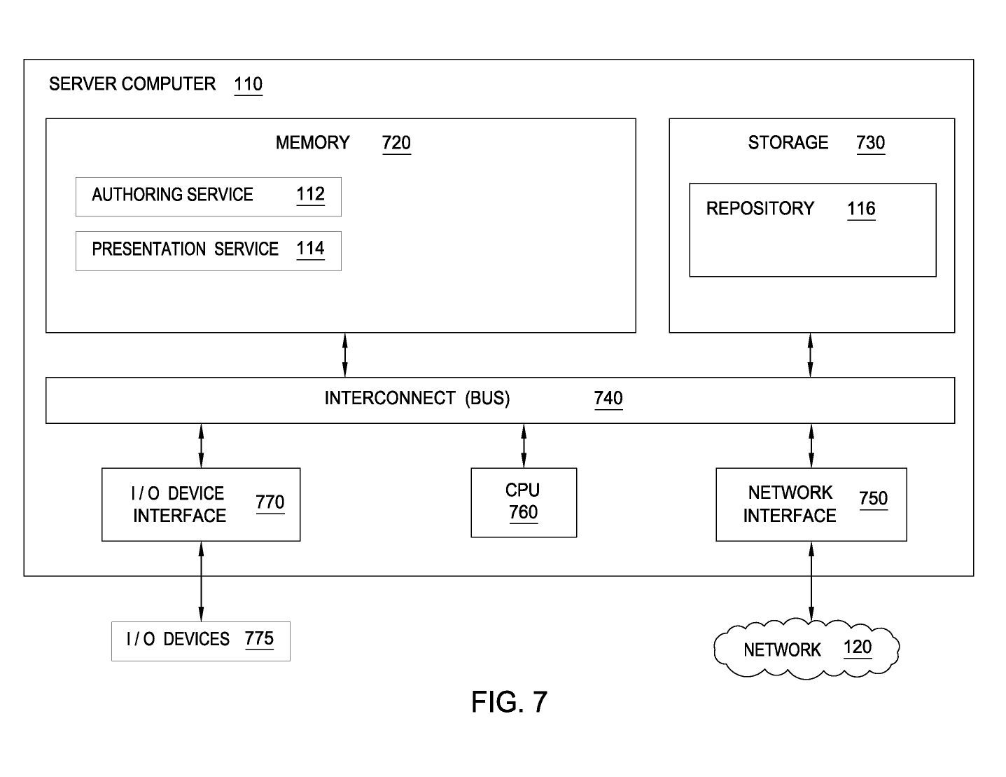

FIG. 7 illustrates an example server computer 110 configured with an authoring service 112 and a presentation service 114, according to one embodiment. As shown, the server computer 110 includes, without limitation, a central processing unit (CPU) 760, a network interface 750 coupled to a network 120, a memory 720, and storage 730, each connected to an interconnect (bus) 740. The server computer 110 may also include an I/O device interface 770 connecting I/O devices 775 (e.g., keyboard, display, mouse, three-dimensional (3D) scanner, and/or touchscreen) to the server computer 110. Further, in context of this disclosure, the computing elements shown in server computer 110 may correspond to a physical computing system (e.g., a system in a data center) or may be a virtual computing instance executing within a computing cloud.

The CPU 760 retrieves and executes programming instructions stored in the memory 720 as well as stores and retrieves application data residing in the storage 730. The interconnect 740 is used to transmit programming instructions and application data between the CPU 760, I/O devices interface 770, storage 730, network interface 750, and memory 720. Note, CPU 760 is included to be representative of a single CPU, multiple CPUs, a single CPU having multiple processing cores, and the like. And the memory 720 is generally included to be representative of a random access memory. The storage 730 may be a disk drive storage device. Although shown as a single unit, the storage 730 may be a combination of fixed and/or removable storage devices, such as fixed disc drives, removable memory cards, or optical storage, network attached storage (NAS), or a storage area-network (SAN).

Illustratively, the memory 720 includes the authoring service 112 and presentation service 114. The storage 730 includes the repository 116. As discussed, the authoring service 112 creates learning paths according to input from authors. Each learning path includes various nodes that in turn include content 142. The authoring service 112 stores the learning paths, nodes, and content 142, within the repository 116. The presentation service 114 retrieves the learning path, nodes, and content 142, in response to requests from users. The presentation service 114 also transmits the content 142, within formatted documents to the user.

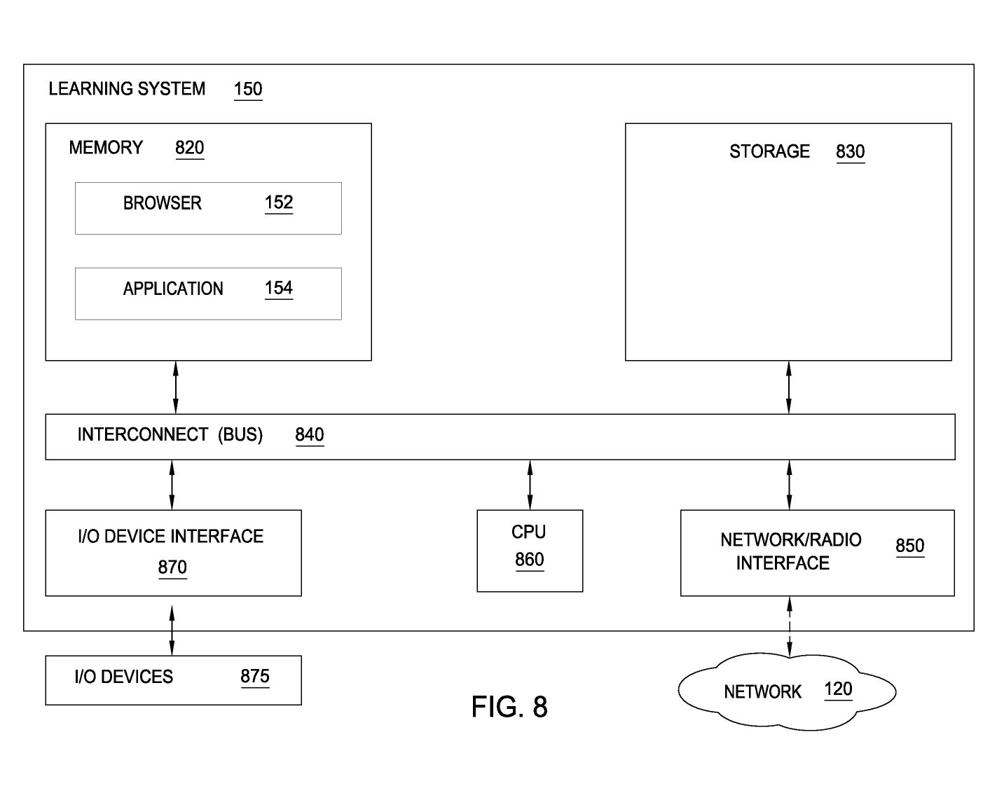

FIG. 8 illustrates an example learning system 150, according to one embodiment. In this example, learning system 150 is used to be representative of a computer system. Of course, embodiments of the invention may be adapted for use with a variety of computing devices, including PDAs, handheld video game systems, tablet computers, and other computing devices. As shown, the learning system 150 includes, without limitation, a central processing unit (CPU) 860, a network/radio interface 850 coupled to a network 120, a memory 820, and storage 830, each connected to an interconnect (bus) 840. The learning system 150 may also include an I/O device interface 870 connecting I/O devices 875 (e.g., keyboard, display, mouse, three-dimensional (3D) scanner, and/or touchscreen) to the learning system 150. Further, in context of this disclosure, the computing elements shown in learning system 150 may correspond to a physical computing system (e.g., a system in a data center) or may be a virtual computing instance executing within a computing cloud.

The CPU 860 retrieves and executes programming instructions stored in the memory 820 as well as stores and retrieves application data residing in the storage 830. The interconnect 840 is used to transmit programming instructions and application data between the CPU 860, I/O devices interface 870, storage 830, network/radio interface 850, and memory 820. Note, CPU 860 is included to be representative of a single CPU, multiple CPUs, a single CPU having multiple processing cores, and the like. And the memory 820 is generally included to be representative of a random access memory. The storage 830 may be a disk drive storage device. Although shown as a single unit, the storage 830 may be a combination of fixed and/or removable storage devices, such as fixed disc drives, removable memory cards, or optical storage, network attached storage (NAS), or a storage area-network (SAN).

Illustratively, the memory 830 includes browser 152 and an application 154. As discussed, a user can assess a learning path associated with the application 154 through the browser. The user can thereby learn about the application 154 from a variety of curated content 142 included within the associated learning path. Note, that the user may also access a learning path associated with a topic or application other than the application 154. Further, the user may access the learning path from a different device, while using the application 154.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method for curating content to include in a learning path, the method comprising:
receiving a plurality of nodes, wherein each node is associated with a topic;
receiving an arrangement for the plurality of nodes defining the learning path;
for each node:
receiving curated content, related to the topic, to associate with the node, and
storing the node and curated content in a repository; and
publishing the learning path.

2. The method of claim 1, wherein receiving the curated content comprises receiving a universal resource locator (URL) of a resource associated with the topic.

3. The method of claim 2, further comprising:
retrieving the resource from the URL;
presenting the resource to an author;
modifying the resource in response to editing changes made by an author; and
storing the modified resource as the curated content.

4. The method of claim 1, wherein storing the curated content in the repository comprises storing a link to the curated content in the repository.

5. The method of claim 1, wherein associating the curated content with the node comprises storing the curated content in the repository.

6. The method of claim 1, further comprising:
receiving a request to view the learning path; and
presenting the plurality of nodes arranged according to the learning path.

7. The method of claim 1, further comprising:
receiving a request identifying one of the nodes in the learning path;
retrieving the curated content associated with the identified node from the repository; and
presenting the curated content.

8. A computer-readable storage medium storing instructions that, when executed by a processor, cause the processor to perform an operation for curating content to include in a learning path, the method comprising:
receiving a plurality of nodes, wherein each node is associated with a topic;
receiving an arrangement for the plurality of nodes defining the learning path; and
for each node:
receiving curated content, related to the topic, to associate with the node, and
storing the node and curated content in a repository, and
publishing the learning path.

9. The computer readable storage medium of claim 8, wherein receiving the curated content comprises receiving a universal resource locator (URL) of a resource associated with the topic.

10. The computer readable storage medium of claim 9, wherein the operation further comprises:
retrieving the resource from the URL;
presenting the resource to an author;
modifying the resource in response to editing changes made by an author; and
storing the modified resource as the curated content.

11. The computer readable storage medium of claim 8, wherein storing the curated content in the repository comprises storing a link to the curated content in the repository.

12. The computer readable storage medium of claim 8, wherein associating the curated content with the node comprises storing the curated content within the node.

13. The computer readable storage medium of claim 8, wherein the operation further comprises:
receiving a request to view the learning path; and
presenting the plurality of nodes arranged according to the learning path.

14. The computer readable storage medium of claim 8, wherein the operation further comprises:
receiving a request identifying one of the nodes in the learning path;
retrieving the curated content associated with the identified node from the repository; and
presenting the curated content.

15. A computer system, comprising:
a memory; and
a processor storing one or more programs configured to perform an operation for curating content to include in a learning path, the method comprising:
receiving a plurality of nodes, wherein each node is associated with a topic,
receiving an arrangement for the plurality of nodes defining the learning path,
for each node:
receiving curated content, related to the topic, to associate with the node; and
storing the node and curated content in a repository, and
publishing the learning path.

16. The system of claim 15, wherein receiving the curated content comprises receiving a universal resource locator (URL) of a resource associated with the topic.

17. The system of claim 16, wherein the operation further comprises:
retrieving the resource from the URL;
presenting the resource to an author;
modifying the resource in response to editing changes made by an author; and
storing the modified resource as the curated content.

18. The system of claim 15, wherein storing the curated content in the repository comprises storing a link to the curated content in the repository.

19. The system of claim 15, wherein associating the curated content with the node comprises storing the curated content within the node.

20. The system of claim 15, wherein the operation further comprises:
receiving a request to view the learning path; and
presenting the plurality of nodes arranged according to the learning path.

21. The system of claim 15, wherein the operation further comprises:
receiving a request identifying one of the nodes in the learning path;
retrieving the curated content associated with the identified node from the repository; and
presenting the curated content.
